(19) United States
(12) Patent Application Publication
(10) Pub. No.: US 2014/0286537 A1
(43) Pub. Date: Sep. 25, 2014

(54) MEASUREMENT DEVICE, MEASUREMENT METHOD, AND COMPUTER PROGRAM PRODUCT

(71) Applicant: KABUSHIKI KAISHA TOSHIBA, Tokyo (JP)

(72) Inventors: Akihito Seki, Yokohama-shi (JP); Satoshi Ito, Kawasaki-shi (JP); Yuta Itoh, Kawasaki-shi (JP); Masaki Yamazaki, Fuchu-shi (JP); Hideaki Uchiyama, Kawasaki-shi (JP)

(73) Assignee: KABUSHIKI KAISHA TOSHIBA, Tokyo (JP)

(21) Appl. No.: 14/194,979

(22) Filed: Mar. 3, 2014

(30) Foreign Application Priority Data
Mar. 25, 2013 (JP) 2013-062740

(51) Int. Cl. G06T 7/00

(52) U.S. Cl. CPC G06T 7/0044
USPC 382/107

(57) ABSTRACT

According to an embodiment, a measurement device includes an image acquisition unit, a time acquisition unit, and first and second calculators. The image acquisition unit is configured to acquire a reference image that is of an object captured at a first viewpoint as well as a plurality of asynchronous images of the object each captured at a second viewpoint at a time different from when the reference image is captured. The time acquisition unit is configured to acquire an image capture time of the reference image and an image capture time of each asynchronous image. The first calculator is configured to calculate a difference in the image capture times between the reference image and each asynchronous image. The second calculator is configured to calculate a spatial position of the object based on the reference image, the asynchronous images, and a plurality of the differences in the image capture time.

### CROSS-REFERENCE TO RELATED APPLICATION

This application is based upon and claims the benefit of priority from Japanese Patent Application No. 2013-062740, filed on Mar. 25, 2013; the entire contents of which are incorporated herein by reference.

### FIELD

Embodiments described herein relate generally to a measurement device, a measurement method, and a computer program product.

### BACKGROUND

There is known a technique in which two or more cameras installed at mutually different positions capture an image of a moving body so that a spatial position of the moving body is estimated by using the image captured by the respective cameras.

Where each camera captures the image of the moving body at a different time (an image capture time is unknown), for example, the technique of estimating the spatial position of the moving body is implemented by matching feature points between two or more stereoscopic moving images captured by the respective cameras, estimating a difference in the image capture time between the stereoscopic moving images, and correcting a difference amount.

While the related art described above estimates the spatial position of an object by using a plurality of images captured at an unknown image capture time, there is also a case where the spatial position of the object is calculated by using a plurality of images captured at a known image capture time from mutually different viewpoints. In this case, there is no need to estimate the difference in the image capture time as is in the related art described above.

### BRIEF DESCRIPTION OF THE DRAWINGS

FIG. 1 is a diagram illustrating an example of a photographing condition according to a first embodiment;

FIG. 2 is a diagram illustrating an example of an image according to the first embodiment;

FIG. 3 is a diagram illustrating an example of the image according to the first embodiment;

FIG. 4 is a block diagram illustrating an example of a measurement device according to the first embodiment;

FIG. 5 is a diagram illustrating an example of a plurality of asynchronous images according to the first embodiment;

FIG. 6 is a diagram illustrating an example of a difference in an image capture time according to the first embodiment;

FIG. 7 is a diagram illustrating an example of an estimated image according to the first embodiment;

FIG. 8 is a diagram illustrating a volume intersection method according to the first embodiment;

FIG. 9 is a diagram illustrating an example of a method of calculating a region by the volume intersection method according to the first embodiment;

FIG. 10 is a diagram illustrating an example of the method of calculating the region by the volume intersection method according to the first embodiment;

FIG. 11 is a flowchart illustrating a process example according to the first embodiment;

FIG. 12 is a block diagram illustrating an example of a measurement device according to a second embodiment;

FIG. 13 is a diagram illustrating an example of a method of estimating image quality according to the second embodiment;

FIG. 14 is a flowchart illustrating a process example according to the second embodiment;

FIG. 15 is a schematic diagram illustrating an example of an expected environment according to a third embodiment;

FIG. 16 is a diagram illustrating an example of an image acquired by an image acquisition unit according to a modification;

FIG. 17 is a diagram illustrating a difference in an image capture time according to the modification; and

FIG. 18 is a diagram illustrating an example of a hardware configuration of a measurement device according to each embodiment and the modification.

### DETAILED DESCRIPTION

According to an embodiment, a measurement device includes an image acquisition unit, a time acquisition unit, a first calculator, and a second calculator. The image acquisition unit is configured to acquire a reference image that is an image of an object captured at a first viewpoint as well as a plurality of asynchronous images of the object each captured at a second viewpoint at a time different from when the reference image is captured. The time acquisition unit is configured to acquire an image capture time of the reference image and an image capture time of each of the asynchronous images. The first calculator is configured to calculate a difference in the image capture times between the reference image and each of the asynchronous images. The second calculator is configured to calculate a spatial position of the object on the basis of the reference image, the asynchronous images, and a plurality of the differences in the image capture time.

Embodiments will now be described in detail with reference to the attached drawings.

### First Embodiment

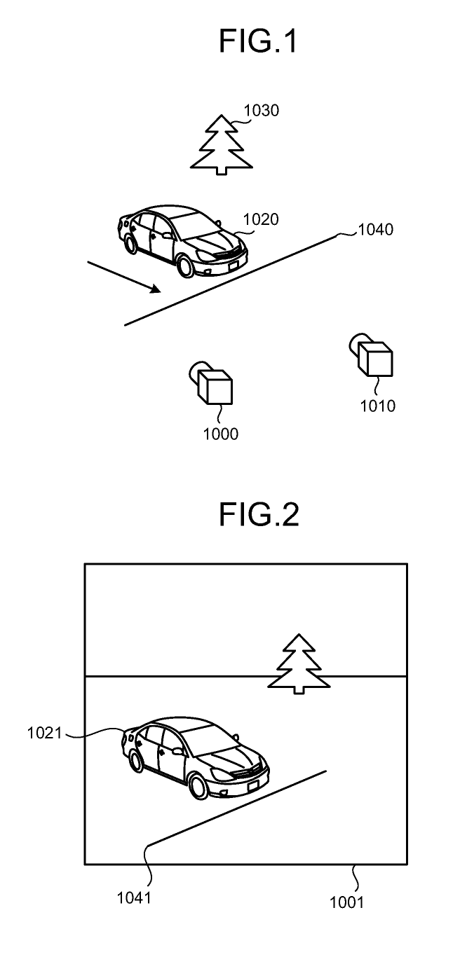

FIG. 1 is a diagram illustrating an example of a photographing condition according to a first embodiment. As illustrated in FIG. 1, an image capturing device 1000 is disposed at a first viewpoint, and an image capturing device 1010 is disposed at a second viewpoint located at a different position from the first viewpoint. It is assumed in the first embodiment that a digital camera is used as the image capturing device 1000 and the image capturing device 1010, though something other than the digital camera may be used. While it is further assumed in the first embodiment that there is one second viewpoint, there may be a plurality of second viewpoints located at different positions.

The image capturing devices 1000 and 1010 capture an image of objects 1020, 1030, and 1040. Here, the object 1020 is a moving body whereas the objects 1030 and 1040 are non-moving bodies. The object 1040 is a marking drawn on the ground.

In the first embodiment, the image capturing devices 1000 and 1010 capture an image not synchronously with each other (at the same time) but asynchronously from each other (at different times). It is normally required that some control signal be shared and used between image capturing devices in order for a plurality of image capturing devices to capture an image synchronously. However, it is difficult for the image capturing devices to share the control signal when the image capturing devices are installed apart from one another or connected to different systems.

In the first embodiment, the image capturing device 1000 and the image capturing device 1010 under such condition capture an image at different image capture times (asynchronously), whereby a position of the object 1020 (the moving body) on the image captured by the image capturing device 1000 differs from a position of the object 1020 (the moving body) on the image captured by the image capturing device 1010.

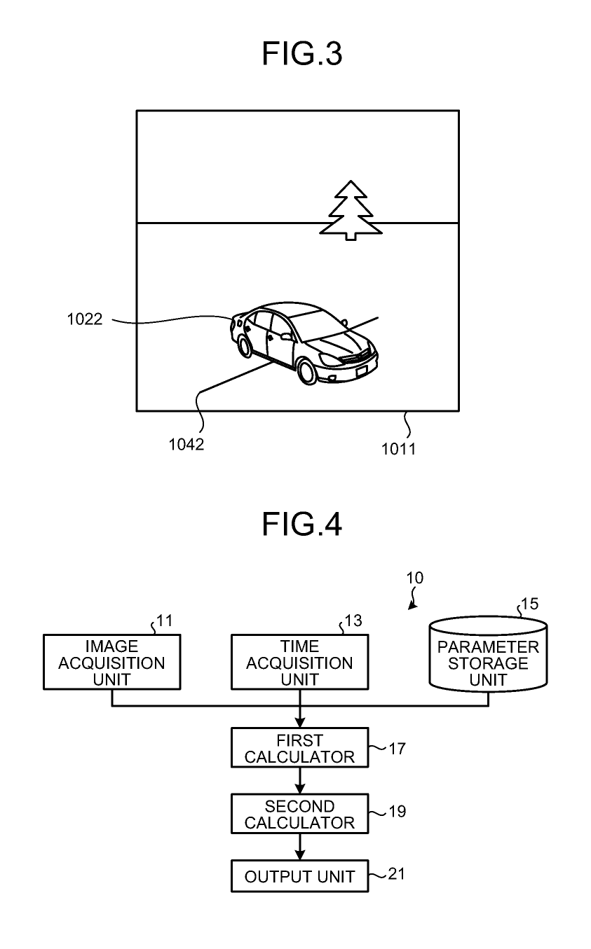

FIG. 2 is a diagram illustrating an example of an image 1001 captured by the image capturing device 1000 according to the first embodiment, while FIG. 3 is a diagram illustrating an example of an image 1011 captured by the image capturing device 1010 according to the first embodiment. An object image 1021 and an object image 1041 within the image 1001 are captured images of the object 1020 and the object 1040, respectively, while an object image 1022 and an object image 1042 within the image 1011 are captured image of the object 1020 and the object 1040, respectively.

The object 1040 being a non-moving body (a stationary object) and the object 1020 being a moving body, it can be understood that the image 1001 and the image 1011 are captured at different times because the position of the object image 1021 with respect to the object image 1041 within the image 1001 is different from the position of the object image 1022 with respect to the object image 1042 within the image 1011.

FIG. 4 is a block diagram illustrating an example of a measurement device 10 according to the first embodiment. As illustrated in FIG. 1, the measurement device 10 includes an image acquisition unit 11, a time acquisition unit 13, a parameter storage device 15, a first calculator 17, a second calculator 19, and an output unit 21.

The image acquisition unit 11, the time acquisition unit 13, the first calculator 17, and the second calculator 19 may be implemented by a processor such as a CPU (Central Processing Unit) executing a program, namely by software, hardware such as an IC (Integrated Circuit), or the software and the hardware used together.

The parameter storage device 15 stores various programs executed by the measurement device 10 as well as data used in various processes performed by the measurement device 10. The parameter storage device 15 can be implemented by a storage such as an HDD (Hard Disk Drive), an SSD (Solid State Drive), a memory card, an optical disk, a ROM (Read Only Memory), or a RAM (Random Access Memory) that can magnetically, optically, or electrically store information.

The output unit 21 may be implemented by a display such as a liquid crystal display or a touch panel display for outputting display, a printer for outputting print, or by the combination of the display and the printer.

The image acquisition unit 11 acquires a reference image of an object imaged at the first viewpoint and a plurality of asynchronous images of the object imaged at the second viewpoint each at a different time from when the reference image is captured.

In the first embodiment, the image acquisition unit 11 acquires an image captured by the image capturing device 1000 as the reference image. Here, the image acquisition unit 11 acquires the image 1001 as the reference image but may acquire a different image.

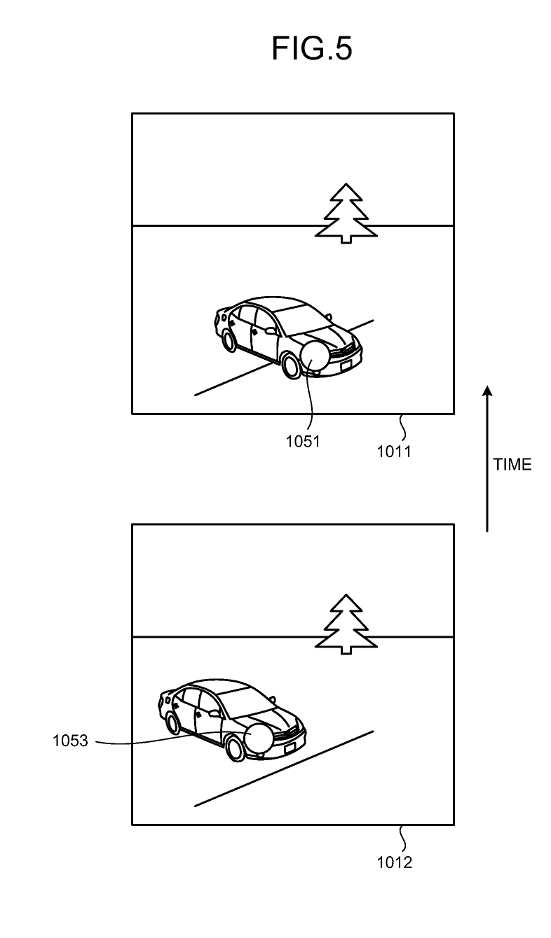

The image acquisition unit 11 further acquires, as the plurality of asynchronous images, the plurality of images captured by the image capturing device 1010 at different image capture times. FIG. 5 is a diagram illustrating an example of the plurality of asynchronous images acquired by the image acquisition unit 11 according to the first embodiment. Here, as illustrated in FIG. 5, the image acquisition unit 11 acquires the image 1011 and an image 1012 which is captured by the image capturing device 1010 before the image 1011 is captured, where the images 1011 and 1012 may not be the only images captured.

Note that the image acquisition unit 11 may acquire the image 1001, the image 1011, and the image 1012 through a network as long as the image acquisition unit 11 is connected to the image capturing device 1000 and the image capturing device 1010 through the network. The image acquisition unit 11 may also acquire the image 1001, the image 1011, and the image 1012 from the image capturing device 1000 and the image capturing device 1010 through a storage medium.

The time acquisition unit 13 acquires the image capture time of the reference image as well as the image capture time of each of the plurality of asynchronous images. Specifically, the time acquisition unit 13 acquires the image capture time of the image 1012 when the image 1012 is captured by the image capturing device 1010, acquires the image capture time of the image 1001 when the image 1001 is captured by the image capturing device 1000, and acquires the image capture time of the image 1011 when the image 1011 is captured by the image capturing device 1010.

The time acquisition unit 13 then associates the acquired image capture times with the corresponding image 1012, image 1001, and image 1011 acquired by the image acquisition unit 11. Note that the time acquisition unit 13 may associate the acquired image capture times with the corresponding image 1012, image 1001, and image 1011 at a point when these images are captured by the image capturing device 1000 and the image capturing device 1010 so that the image acquisition unit 11 may acquire the image 1012, the image 1001, and the image 1011 with which the image capture times are associated.

The image capture time need only be used to calculate the relative time difference between a time at which an image is captured by the image capturing device 1000 and a time at which an image is captured by the image capturing device 1010, and can be provided in the form of Coordinated Universal Time (Greenwich Mean Time), Japan Standard Time, or GPS (Global Positioning System) time, for example. The GPS time is a time based on a signal transmitted from a GPS.

The time based on the Coordinated Universal Time or the Japan Standard Time may be acquired via a network by the time acquisition unit 13 being connected to an external NTP server while using an NTP (Network Time Protocol). The time acquisition unit 13 may also acquire the time based on the Coordinated Universal Time or the Japan Standard Time by acquiring a signal from a radio clock (particularly a standard radio wave signal), time information included in a control signal transmitted from a base station of a mobile phone, time information superimposed on teletext data for FM radio broadcasting, or a Time Offset Table included in BS digital broadcasting or digital terrestrial broadcasting.

The GPS time may be acquired by using a method by which the time acquisition unit 13 acquires the time from a signal transmitted from a satellite such as a GLONASS (Global Navigation Satellite System).

The parameter storage device 15 stores a parameter corresponding to the image capturing device 1000 and the image capturing device 1010. In particular, the parameter storage device 15 stores an internal parameter and an external parameter corresponding to each of the image capturing device 1000 and the image capturing device 1010. The internal parameter includes a focal length and an image center pertaining to the image capturing device. The external parameter includes a spatial position and an orientation pertaining to the image capturing device.

The first calculator 17 calculates a difference in the image capture times between the reference image and each of the plurality of asynchronous images. In particular, the first calculator 17 calculates the difference in the image capture times between the image capture time of the image 1001 acquired by the time acquisition unit 13 and the image capture time of each of the image 1012 and the image 1011 acquired by the time acquisition unit 13.

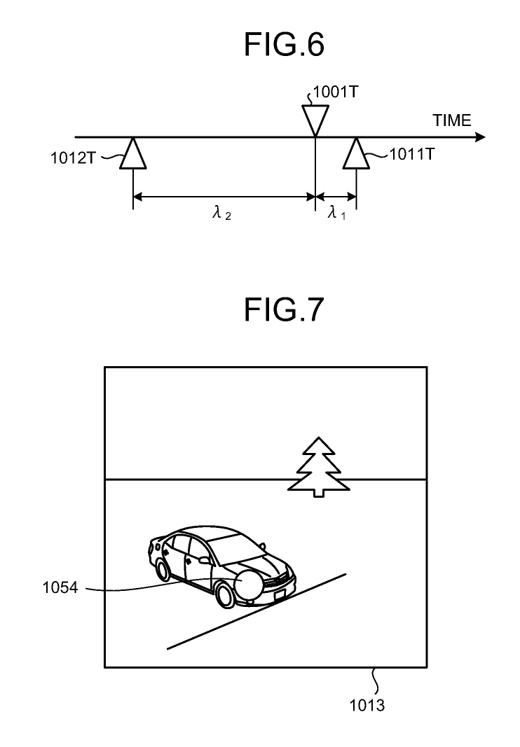

FIG. 6 is a diagram illustrating an example of the difference in the image capture times according to the first embodiment. According to the example illustrated in FIG. 6, the image 1012 is captured at an image capture time 1012T, the image 1001 is captured at an image capture time 1001T, and the image 1011 is captured at an image capture time 1011T. Also in the example illustrated in FIG. 6, the difference between the image capture time 1001T and the image capture time 1011T (time lag of the image capture time 1011T with respect to the image capture time 1001T) corresponds to λ₁, while the difference between the image capture time 1001T and the image capture time 1012T (time lag of the image capture time 1012T with respect to the image capture time 1001T) corresponds to λ₂. Here, λ₁ has a negative value because the time 1011T comes after the time 1001T, while λ₂ has a positive value because the time 1012T comes before the time 1001T.

The second calculator 19 calculates the spatial position of an object on the basis of the reference image, the plurality of asynchronous images, and a plurality of differences in the image capture times. In particular, the second calculator 19 uses the plurality of asynchronous images and the plurality of differences in the image capture times to generate an estimated image that is estimated to be captured at the second viewpoint at the same time the reference image is captured. The second calculator 19 then uses the reference image, the estimated image, the parameter pertaining to the image capturing device 1000, and the parameter pertaining to the image capturing device 1010 to calculate the spatial position of the object.

First, the second calculator 19 uses the image 1011, the image 1012, the difference in the image capture time λ₁, and the difference in the image capture time λ₂ to calculate an optical flow between the image 1011 and the image 1012 and generate the estimated image. FIG. 7 is a diagram illustrating an example of the estimated image according to the first embodiment. That is, an image 1013 illustrated in FIG. 7 is an image estimated to be captured by the image capturing device 1010 at the image capture time 1001T.

Here, the optical flow represents the movement among a plurality of images where a coordinate u′₀ of a point 1051 (refer to FIG. 5) on the image 1011 and a coordinate u′₁ of a point 1053 (refer to FIG. 5) on the image 1012 are expressed by Equation (1). Note that the point 1053 on the image 1012 corresponds to the point 1051 on the image 1011.

u′₁=u′₀+m (1)

The “m” in the equation represents a two-dimensional motion vector of the image.

A coordinate u′₀ᵥ of a point 1054 (refer to FIG. 7) on the image 1013 is calculated by Equation (2) by using the differences in the image capture times λ₁ and λ₂. Here, Equation (2) indicates that the movement is interpolated according to the ratio of the differences in the image capture times. The point 1054 on the image 1013 corresponds to the point 1051 on the image 1011.

$${u}_{0 v}^{′} = {u}_{0}^{′} + \frac{{λ}_{1}}{\vert {λ}_{2} - {λ}_{1} \vert} m \qquad ( 2 )$$

The second calculator 19 performs the process having been described up to this point on the entire image and to acquire the image 1013 that is the estimated image. Note that there is no distinction between the moving body and the non-moving body in the image 1013.

Next, the second calculator 19 uses the image 1001, the image 1013, the internal parameter and the external parameter pertaining to the image capturing device 1000, and the internal parameter and the external parameter pertaining to the image capturing device 1010 to calculate the spatial position (particularly the spatial position of a target including the object 1020) of the object 1020 (the moving body).

A method of calculating the spatial position can be roughly classified into two methods including a triangulation method and a volume intersection method.

In the triangulation method, a position corresponding between the image 1001 and the image 1013 is found first so that the spatial position is estimated from a parallax of the corresponding positions found. This is equivalent to finding the coordinate u′₀ᵥ of the point 1054 (refer to FIG. 7) on the image 1013 and the coordinate u₀ of a point on the image 1001 corresponding to the point 1054.

The second calculator 19 calculates the coordinate u′₀ᵥ and the coordinate u₀ by using Equation (3), for example.

$$arg {min}_{d} E = {\sum }_{x ∈ W} {[ {I}_{1012} ( x + d ) - {I}_{1001} ( x ) ]}^{2} \qquad ( 3 )$$

The “W” in the equation represents a window region around the point having the coordinate u₀, where the central coordinate in the window region of x+d corresponds to the coordinate u′₀ᵥ. While an SSD (Sum of Squared Difference) is used as an evaluation function, another evaluation function may be used instead.

Where parallelization is performed beforehand between the image capturing device 1000 and the image capturing device 1010, the point 1054 on the image 1013 is at the same horizontal position in the image as the point on the image 1001 corresponding to the point 1054 (that is, epipolar lines are parallel), whereby the second calculator 19 can calculate the point on the image 1001 corresponding to the point 1054 by searching in a horizontal direction. Where the parallelization is not performed beforehand between the image capturing device 1000 and the image capturing device 1010, the point on the image 1001 corresponding to the point 1054 can be calculated by searching the epipolar lines on the image 1013.

When the homogeneous coordinate of the spatial position is x˜=[X Y Z 1], Equation (4) holds true with a perspective projection matrix P₁₀₀₀ of the image capturing device 1000 including the internal parameter and the external parameter of the image capturing device 1000, while Equation (5) holds true with a perspective projection matrix P₁₀₁₀ of the image capturing device 1010 including the internal parameter and the external parameter of the image capturing device 1010. Note that “˜” represents the homogeneous coordinate.

ũ′₀ᵥ=P₁₀₁₀\tilde{X} (4)

ũ₀=P₁₀₀₀\tilde{X}(5)

The second calculator 19 can calculate the spatial position by solving Equations (4) and (5) for X.

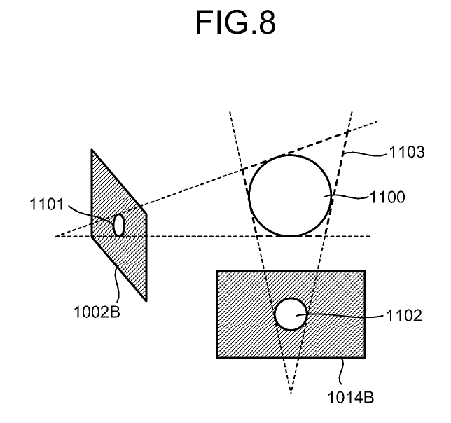

The visual hull method will now be described. FIG. 8 is a diagram illustrating the visual hull method according to the first embodiment. As illustrated in FIG. 8, the second calculator 19 acquires a region 1101 within an image 1002B and a region 1102 within an image 1014B by extracting the silhouette of an object 1100 from the image 1002B and the image 1014B captured by a plurality of image capturing devices (two devices in the example illustrated in FIG. 8). The second calculator 19 then projects a region, in which the object 1100 possibly exists, into a three-dimensional space and estimates a space 1103 in which the object 1100 is settled. Note that in order to bring the space 1103 closer to the true shape of the object 1100, the images may be captured from various directions by increasing the number of image capturing devices, for example.

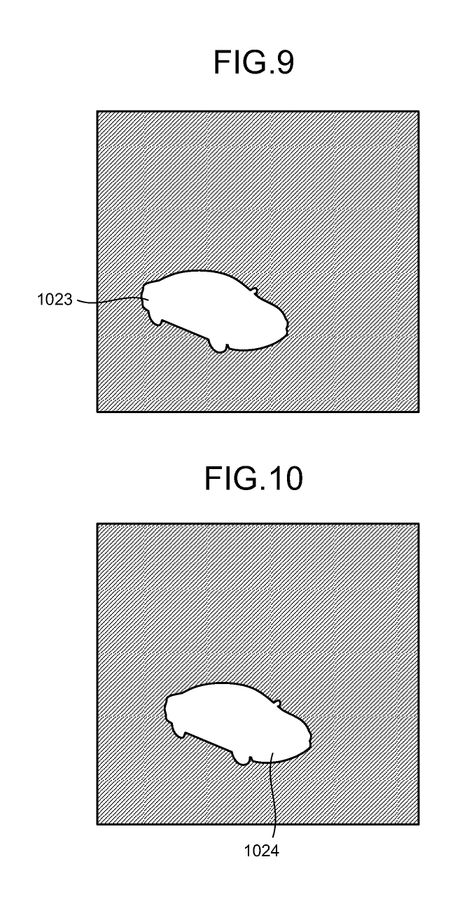

FIGS. 9 and 10 are diagrams illustrating an example of a method of calculating the region by the visual hull method according to the first embodiment, where FIG. 9 illustrates a region 1023 of the image 1001 as an example of the region 1101 while FIG. 10 illustrates a region 1024 of the image 1013 as an example of the region 1102. In order to extract the regions 1023 and 1024, images captured by a single image capturing device at different times may be used to extract a region which has changed as a result of interframe difference performed, a region with the value of the optical flow larger than a predetermined value, or an outline of a specific object by performing a statistical process such as pattern recognition.

The output unit 21 outputs the spatial position of the object.

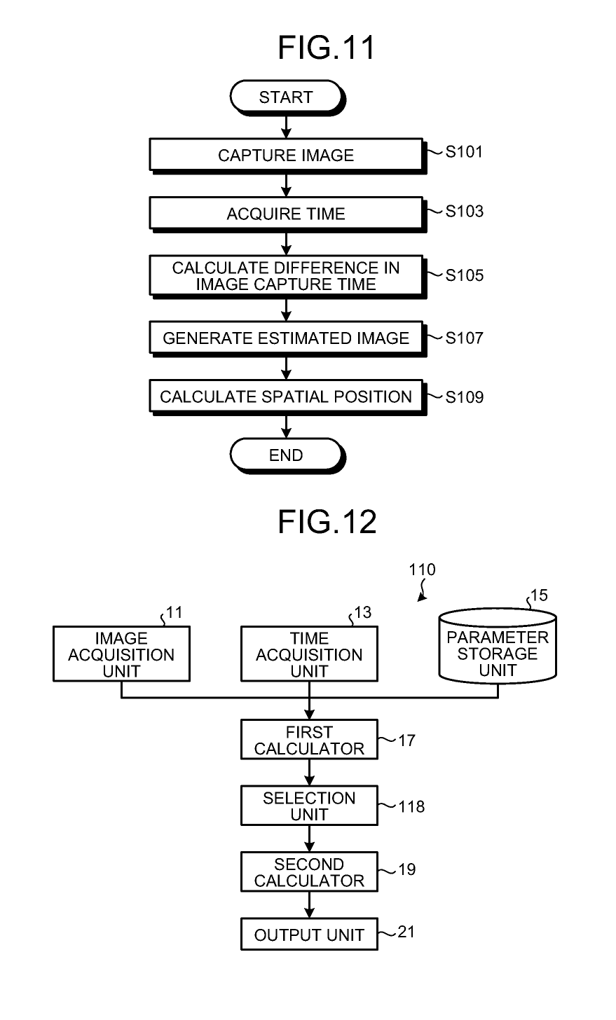

FIG. 11 is a flowchart illustrating an example of a flow of a process performed by the measurement device 10 according to the first embodiment.

First, the image acquisition unit 11 acquires the reference image which is the image of the moving body captured at the first viewpoint and the plurality of asynchronous images which is the image of the moving body captured at the second viewpoint at mutually different times from when the reference image is captured (step S101).

Subsequently, the time acquisition unit 13 acquires the image capture time of the reference image as well as the image capture time of each of the plurality of asynchronous images (step S103).

The first calculator 17 then calculates the difference in the image capture times between the reference image and each of the plurality of asynchronous images (step S105).

The second calculator 19 thereafter uses the plurality of asynchronous images and the plurality of differences in the image capture times to generate the estimated image that is estimated to be captured at the second viewpoint at the same time the reference image is captured (step S107).

Thereafter, the second calculator 19 uses the reference image, the estimated image, the parameter pertaining to the image capturing device 1000, and the parameter pertaining to the image capturing device 1010 to calculate the spatial position of the moving body (step S109).

According to the first embodiment, as described above, the image capture times of the reference image and the plurality of asynchronous images are known, so that the difference in the image capture times between the reference image and the plurality of asynchronous images can be calculated to calculate the spatial position of the moving body from the plurality of images captured at different image capture times by a simple process in which the spatial position of the moving body is calculated on the basis of the reference image, the plurality of asynchronous images, and the plurality of differences in the image capture times.

Furthermore, according to the first embodiment, the spatial position of the moving body can be calculated with one reference image and two asynchronous images, whereby the number of images used to calculate the spatial position of the moving body can be decreased meaning that various costs can also be decreased.

Note that the first embodiment can be used to measure a three-dimensional shape of a pedestrian or a vehicle on the ground from a camera installed at the roof of a building, measure a three-dimensional shape of a target by using a camera installed indoors and a camera installed in a robot, or calculate the position of an obstacle by using a camera installed at a traffic light and an in-vehicle camera.

### Second Embodiment

In a second embodiment, there will be described an example where a second viewpoint is selected for use in the measurement from among a plurality of viewpoints excluding the first viewpoint. Now, there will be mainly described what is different in the second embodiment from the first embodiment, where the description of a component having a similar function to that in the first embodiment will be omitted by assigning to the component the name and the reference numeral similar to that in the first embodiment.

FIG. 12 is a block diagram illustrating an example of a measurement device 110 according to the second embodiment. As illustrated in FIG. 12, what is different from the first embodiment is that a selection unit 118 is included in the measurement device 110 according to the second embodiment.

Note that there is a plurality of viewpoints other than the first viewpoint in the second embodiment.

From among the plurality of viewpoints excluding the first viewpoint, the selection unit 118 selects, as the second viewpoint, a viewpoint which satisfies at least any of the following conditions: an estimation error of the spatial position is smaller than at the other viewpoints; a difference in image capture times between a reference image and an image captured at the viewpoint is smaller than between the reference image and an image captured at the other viewpoints; and the image quality is higher than at the other viewpoints.

First, the viewpoint having the smaller estimation error of the spatial position than at the other viewpoints will be described.

The spatial position of an object is determined by solving Equations (4) and (5) for X, as described above. In other words, the spatial position of an object is determined by a perspective projection matrix of an image capturing device. The selection unit 118 therefore adds a predetermined value ε as an error to a coordinate u′₀ᵥ and estimates a simulated spatial position incorporating the error by solving Equations (6) and (7) for X.

ũ\tilde{′}₀ᵥ+εP₁₀₁₀\tilde{X}ₑ (6)

ũ₀=P₁₀₀₀\tilde{X}ₑ (7)

Then, the selection unit 118 calculates an estimation error value by using Equation (8).

err=|Xₑ−X| (8)

The selection unit 118 performs the process having been described up to this point on the plurality of viewpoints excluding the first viewpoint, calculates the error value for each of the plurality of viewpoints, and selects a viewpoint with the smallest error value as the second viewpoint.

As a result, the viewpoint with the estimation error of the spatial position smaller than that at the other viewpoints can be selected as the second viewpoint, whereby estimation accuracy of the spatial position can be improved.

Next, the viewpoint having the smaller difference in the image capture times between the reference image and the image captured at the viewpoint than between the reference image and the image captured at the other viewpoints will be described.

The second calculator 19 uses the difference in the image capture times between the reference image and the image captured at each of the viewpoints and generates the estimated image that is estimated to be captured at the same time the reference image is captured. Accordingly, the selection unit 118 selects, as the second viewpoint, the viewpoint having the small difference in the image capture times, namely, the viewpoint at which the image is captured at the image capture time close to that of the reference image. This makes it easier to search for a congruent point in calculating the spatial position.

As a result, the viewpoint from which one can search for the congruent point more easily than from the other viewpoints can be selected as the second viewpoint, whereby the estimation accuracy of the spatial position can be improved.

Next, the viewpoint having the higher image quality than the other viewpoints will be described.

The position estimation accuracy of the coordinate u′₀ᵥ decreases when a large amount of noise is included in the image or when there is motion blur caused by a shutter speed or the like of the image capturing device, in which case the value of ε included in Equation (6) as well as the estimation error of the spatial position become larger.

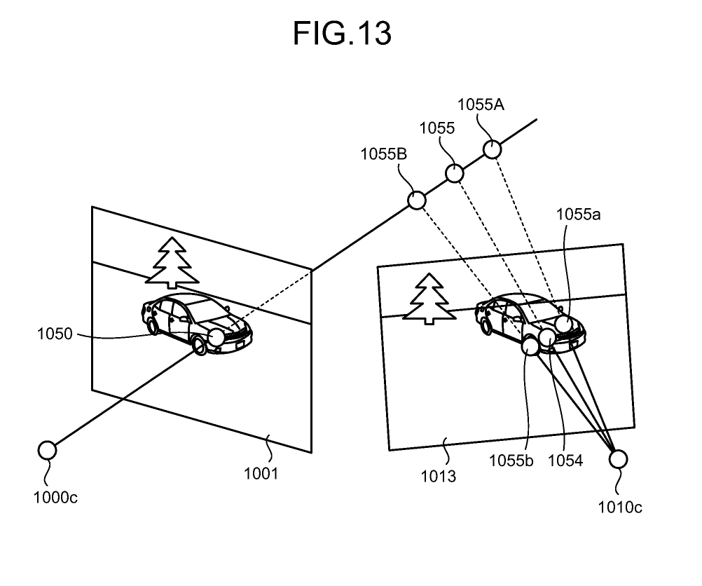

FIG. 13 is a diagram illustrating an example of a method of estimating image quality according to the second embodiment. As illustrated in FIG. 13, the selection unit 118 assumes that there is an error ±Ψ on a straight line connecting a spatial position 1055 of a point 1050 on an image 1001 (a point on the image 1001 corresponding to a point 1054) and an optical center 1000c of an image capturing device 1000, and finds a spatial position 1055A and a spatial position 1055B. Where points 1055a and 1055b correspond to the positions of the spatial positions 1055A and 1055B projected onto an image 1013, the selection unit 118 calculates a cost at the point 1054 and the point 1050 by using Equation (3), for example. Likewise, the selection unit 118 calculates a cost at a position corresponding to each of the spatial positions 1055A and 1055B.

Here, the calculated cost is drastically decreased when the corresponding position is clear, in which case the value of the costs of the spatial positions 1055A, 1055, and 1055B arranged in this order resembles a V shape. When the corresponding position is not clear due to noise or blurring, on the other hand, the value of the costs of the spatial positions 1055A, 1055, and 1055B arranged in this order resembles the shape of a straight line.

Accordingly, the selection unit 118 performs the process having been described up to this point on the plurality of viewpoints excluding the first viewpoint, calculates the value of the costs of the spatial positions 1055A, 1055, and 1055B arranged in this order for each of the plurality of viewpoints, and selects the viewpoint with the value closest to the V shape as the second viewpoint.

As a result, the viewpoint having the higher image quality than the other viewpoints can be selected as the second viewpoint, whereby the estimation accuracy of the spatial position can be improved.

The selection unit 118 selects the viewpoint satisfying at least any of the aforementioned three conditions as the second viewpoint.

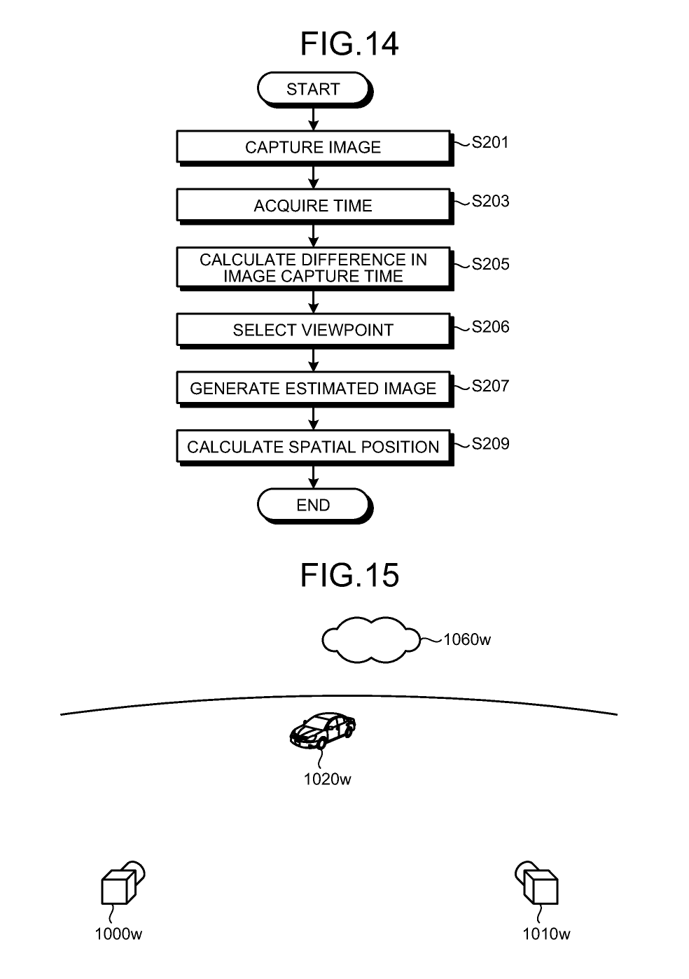

FIG. 14 is a flowchart illustrating an example of a flow of a process performed by the measurement device 110 according to the second embodiment.

The process performed in each of steps S201 to S205 is similar to the process performed in each of steps S101 to S105 in the flowchart illustrated in FIG. 11.

From among the plurality of viewpoints excluding the first viewpoint, the selection unit 118 in step S206 selects, as the second viewpoint, the viewpoint which satisfies at least any of the following conditions: an estimation error of the spatial position is smaller than at the other viewpoints; the difference in image capture times between the image captured at the viewpoint and the reference image is smaller than between the reference image and the image captured at the other viewpoints; and the image quality is higher than at the other viewpoints.

Subsequently, the process performed in each of steps S207 to S209 is similar to the process performed in each of steps S107 to S109 in the flowchart illustrated in FIG. 11.

According to the second embodiment, the viewpoint at which the estimation accuracy of the spatial position increases can be selected as the second viewpoint as described above.

Note that the second embodiment can be suitably applied to a case where measurement is performed with higher accuracy under the environment in which three or more image capturing devices with a common field of vision are installed.

### Third Embodiment

In a third embodiment, as illustrated in FIG. 15, an image capturing device is installed outdoors or the like with the assumption that the position of the image capturing device can be acquired by a GPS or the like. In the third embodiment, position information on image capturing devices 1000w and 1010w that can be acquired by the GPS or the like is used to estimate an external parameter of the image capturing devices 1000w and 1010w.

For example, a second calculator 19 estimates a spatial position and an orientation of the image capturing devices 1000w and 1010w. A perspective projection matrix is required to estimate the spatial position as described above. Note that the perspective projection matrix is also required in performing parallelization.

Here, the perspective projection matrix includes a three-dimensional translation vector indicating a spatial position and a three-by-three rotation matrix indicating the orientation of the image capturing device.

Accordingly, for example, the second calculator 19 in the third embodiment specifies the three-dimensional translation vector from a value obtained by a sensor such as the GPS (an example of a first sensor) that can acquire (estimate) the absolute spatial position. Note that accuracy may be improved by a generally known method such as a DGPS or a combination with another radio wave when effective accuracy cannot be obtained by the GPS.

Moreover, for example, the second calculator 19 specifies the three-by-three rotation matrix from a value obtained by a sensor (an example of a second sensor) that can acquire (estimate) spatial orientation information on the image capturing device. For example, a sensor capable of acquiring (estimating) the spatial orientation information of the image capturing device may be installed in the image capturing device. Note that the three-by-three rotation matrix may be acquired by installing two or more of the first sensor in the image capturing device or using a three-axis geomagnetic field sensor which can measure a geomagnetic field.

The estimation error of the spatial position of a target is small when the image capturing devices are spaced far enough from each other with respect to the estimation error of the spatial position and the orientation of the image capturing device.

### Fourth Embodiment

A fourth embodiment will describe an example of estimating the spatial position of a target such as a cloud or a flying object that is far from an image capturing device installed on the ground. The environment illustrated in FIG. 15 is assumed in the fourth embodiment as well.

The error in estimating the spatial position becomes large in the aforementioned triangulation method when a distance from image capturing devices 1000w and 1010w to a target such as an object (cloud) 1060w is large. Accordingly, the distance between the image capturing devices 1000w and 1010w is set large in the fourth embodiment in order to reduce the error in estimating the spatial position. Note that a signal line connecting the image capturing devices gets longer as the image capturing devices are installed far apart from each other, in which case it is assumed that the connection is made via a LAN or a WAN by using an IP camera or the like.

As a result, the spatial position of a moving object such as the cloud 1060w can be calculated to figure out the spatial position or a speed of the cloud, whereby one can observe or predict sunshine or wind to be used in predicting power generation associated with wind power generation or solar power generation. One can also figure out the spatial position including the altitude as well as a traveling speed of the cloud 1060w. Furthermore, the position of the cloud 1060w can be converted into an absolute position when the image capturing device 1000w and the image capturing device 1010w are equipped with a sensor such as the GPS that can acquire a position, where the absolute position can be superposed on map information or integrated with another observation data.

The fourth embodiment may be applied to estimate the spatial position or the traveling speed of another planet by widely distributing the image capturing devices on the Earth, for example.

Modification

A method of calculating the spatial position different from the method described in each of the aforementioned embodiments will now be described. Described in the method according to a modification is an example where an image other than a reference image is used as an image captured by an image capturing device 1000. Similar to each of the aforementioned embodiments, however, it can be adapted to not use any image other than the reference image.

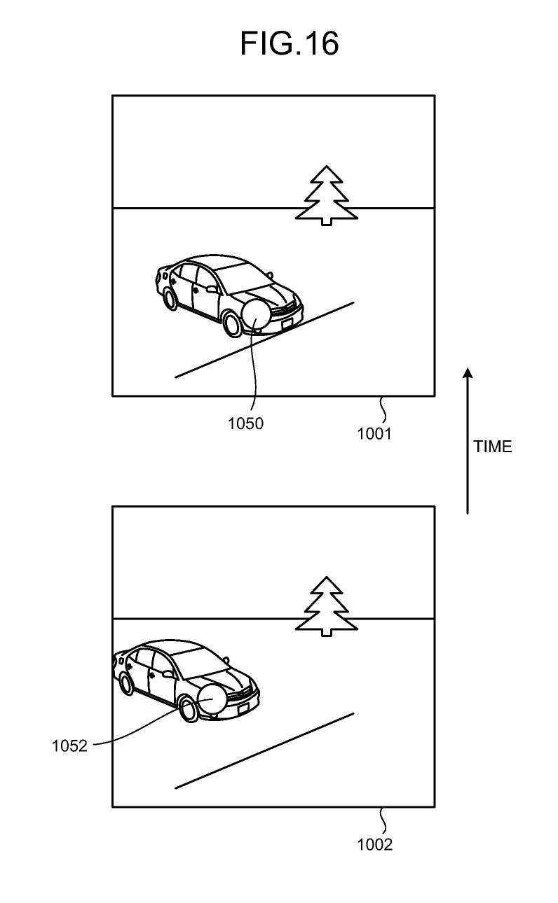

An image acquisition unit 11 acquires a plurality of images captured by the image capturing device 1000 at different image capture times. FIG. 16 is a diagram illustrating an example of the plurality of images acquired by the image acquisition unit 11 according to the modification. As illustrated in FIG. 16, the image acquisition unit 11 in this case acquires, as an example, an image 1001 that is the reference image and an image 1002 captured by the image capturing device 1000 before the image 1001 is captured.

A time acquisition unit 13 acquires the image capture time of the image 1002 once the image 1002 is captured by the image capturing device 1000.

A first calculator 17 calculates the difference in the image capture times between the image capture time of the image 1001 acquired by the time acquisition unit 13 and each of the image capture times of the image 1002, an image 1012, and an image 1011 acquired by the time acquisition unit 13.

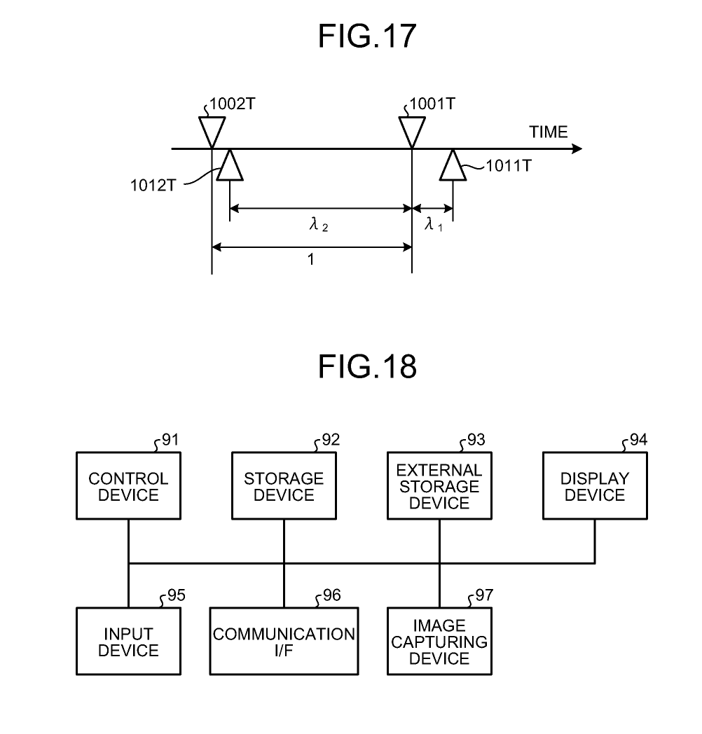

FIG. 17 is a diagram illustrating an example of the difference in the image capture times according to the modification. In the example illustrated in FIG. 17, the image 1002 is captured at an image capture time 1002T. Also in the example illustrated in FIG. 17, λ₁ and λ₂ are normalized such that the difference between an image capture time 1001T and the image capture time 1002T equals 1.

A second calculator 19 extracts a feature point from the reference image as well as a corresponding feature point corresponding to the feature point from each of a plurality of asynchronous images, whereby the spatial position of an object is calculated on the basis of the feature point, the corresponding feature point, and the plurality of differences in the image capture times.

Now, the calculation of the spatial position of the object according to the modification will be described specifically. In the modification, it is assumed that the image 1001, the image 1002, the image 1011, and the image 1012 are parallelized by using an internal parameter and an external parameter of each of the image capturing device 1000 and an image capturing device 1010.

The second calculator 19 first sets a focus point for which the spatial position is to be found. Here, the second calculator 19 sets a point 1050 on the image 1001 as the focus point. In this case, a point 1052 on the image 1002 corresponding to the point 1050 is represented by a coordinate u₁ as expressed in Equation (9) where u₀ denotes a coordinate of the point 1050, Z denotes a depth, and Tₘ=|Tₘₓ T_{my} T_{mz}| denotes the spatial shift of an object 1020.

$${u}_{1} = {u}_{0} + \frac{1}{Z - {T}_{mz}} {A}_{x} {T}_{m} \qquad ( 9 )$$

Note that Aₓ can be found by Equation (10).

$${A}_{x} = [ \begin{matrix}- f & 0 & x - {x}_{0} \\ 0 & - af & y - {y}_{0}\end{matrix} ] \qquad ( 10 )$$

The internal parameter of the image capturing device can be found by Equation (11).

$${A}_{int r} = [ \begin{matrix}f & 0 & {x}_{0} \\ 0 & af & {y}_{0} \\ 0 & 0 & 1\end{matrix} ] \qquad ( 11 )$$

Values f and of can be found by dividing the focal length of the image capturing device by a size per pixel, while values x₀ and y₀ correspond to the coordinates of the optical center of the image. These parameters are set in advance to have the same values in the image capturing device 1000 and the image capturing device 1010 by the parallelization described above.

A point 1051 on the image 1011 corresponding to the point 1050 can be found by Equation (12).

$${u}_{0}^{′} = {u}_{0} + \frac{1}{Z - {λ}_{1} {T}_{mz}} {A}_{x} ( {λ}_{1} {T}_{m} + {T}_{s} ) \qquad ( 12 )$$

A value Tₛ represents a parallel motion vector between the image capturing device 1000 and the image capturing device 1010. The X coordinate has a value other than zero according to the aforementioned parallelization, while the rest has the value equal to zero.

A point 1053 on the image 1012 corresponding to the point 1050 can be found by Equation (13).

$${u}_{1}^{′} = {u}_{0} + \frac{1}{Z - {λ}_{2} {T}_{mz}} {A}_{x} ( {λ}_{2} {T}_{m} + {T}_{s} ) \qquad ( 13 )$$

The second calculator 19 then calculates the corresponding positions of the points 1051 to 1053 corresponding to the point 1050 by estimating the depth Z and the spatial shift Tₘ=|Tₘₓ T_{my} T_{mz}| of the object 1020 that are unknown. Specifically, the second calculator 19 sets an error function E by setting a window region around the point 1050. Here, as illustrated by Equation (14), the error function E corresponds to each SSD between the image 1001 and the image 1002, between the image 1001 and the image 1011, and between the image 1001 and the image 1012.

$$arg {min}_{{T}_{m} , Z} = {\sum }_{x ∈ W} {[ {I}_{1002} ( x + \frac{1}{Z - {T}_{mz}} {A}_{x} {T}_{m} ) - {I}_{1001} ( x ) ]}^{2} + {\sum }_{x ∈ W} {[ {I}_{1011} ( x + \frac{1}{Z - {λ}_{1} {T}_{mz}} {A}_{x} \{ {λ}_{1} {T}_{m} + {T}_{m} \} ) - {I}_{1001} ( x ) ]}^{2} + {\sum }_{x ∈ W} {[ {I}_{1012} ( x + \frac{1}{Z - {λ}_{2} {T}_{mz}} {A}_{x} \{ {λ}_{2} {T}_{m} + {T}_{m} \} ) - {I}_{1001} ( x ) ]}^{2} \qquad ( 14 )$$

The second calculator 19 may find the depth Z and the spatial shift Tₘ=|Tₘₓ T_{my} T_{mz}| with the minimum error function E by means of a gradient method, a simulated annealing method, or a full search. While the SSD is herein used as the error function, an NCC (Normalized Cross Correlation) or an SAD (Sum of Absolute Difference) may be used instead.

While four images including the image 1001 as a reference, the image 1002, the image 1011, and the image 1012 are used in the modification, it is also possible to have one less image excluding the image 1001. In other words, the estimation made by Equation (14) may be performed by using the image 1001, the image 1011, and the image 1012 without using the image 1002, using the image 1001, the image 1002, and the image 1012 without using the image 1011, or using the image 1001, the image 1002, and the image 1011 without using the image 1012. Moreover, three or more images can be used as long as there is one or more images captured by each of the image capturing device 1000 and the image capturing device 1010 is included.

Furthermore, another method of calculating the spatial position of an object may be performed in which a feature point is extracted from each image, the feature point is matched between different images, and the coordinate of the feature point matched between the images is obtained. For example, the position of the point corresponding to the point 1050 that is the feature point on the image 1001 is found in at least two of the image 1002, the image 1011, and the image 1012. As a result, an equation can be set up by using an equation corresponding to Equations (9), (12), and (13), so that the depth Z and the spatial shift Tₘ=|Tₘₓ T_{my} T_{mz}| may be calculated by solving these equations.

Hardware Configuration

FIG. 18 is a block diagram illustrating an example of a hardware configuration of the measurement device according to each embodiment and the modification. As illustrated in FIG. 18, the measurement device according to each embodiment and the modification includes: a control device 91 such as a CPU; a storage device 92 such as a ROM (Read Only Memory) or a RAM (Random Access Memory); an external storage device 93 such as an HDD (Hard Disk Drive) or an SSD (Solid State Drive); a display device 94 such as a display; an input device 95 such as a mouse and a keyboard; a communication I/F 96; and an image capturing device 97 such as a digital camera. The measurement device can be implemented by the hardware configuration of a normal computer.

A program executed by the measurement device according to each embodiment and the modification is incorporated in the ROM or the like in advance to be provided. The program executed by the measurement device according to each embodiment and the modification may also be provided while being stored in a storage medium such as a CD-ROM, a CD-R, a memory card, a DVD, or a flexible disk (FD) that can be read by a computer, the program having an installable or executable file format. Alternatively, the program executed by the measurement device according to each embodiment and the modification may be provided while being stored in a computer connected to a network such as the Internet and downloaded via the network.

The program executed by the measurement device according to each embodiment and the modification has a module configuration which allows each unit described above to be implemented on the computer. The actual hardware is configured such that each unit is implemented on the computer when the control device 91 reads the program from the external storage device 93 into the storage device 92 and executes the program.

According to each embodiment and the modification, the spatial position of the object can easily be calculated from the plurality of images captured at the different image capture times, as described above.

For example, each step in the flowchart according to the aforementioned embodiments may be performed by changing the execution sequence, executing a plurality of steps simultaneously, or executing the steps in a different order each time it is executed as long as the steps does not contradict the nature thereof.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A measurement device comprising:
an image acquisition unit configured to acquire a reference image that is an image of an object captured at a first viewpoint as well as a plurality of asynchronous images of the object each captured at a second viewpoint at a time different from when the reference image is captured;
a time acquisition unit configured to acquire an image capture time of the reference image and an image capture time of each of the asynchronous images;
a first calculator configured to calculate a difference in the image capture times between the reference image and each of the asynchronous images; and
a second calculator configured to calculate a spatial position of the object on the basis of the reference image, the asynchronous images, and a plurality of the differences in the image capture time.

2. The measurement device according to claim 1, wherein
the second calculator is configured to
use the asynchronous images and the differences in the image capture time to generate an estimated image that is estimated to be captured at the second viewpoint at the same time the reference image is captured, and
calculate the spatial position of the object by using the reference image, the estimated image, a parameter pertaining to an image capturing device used in capturing an image at the first viewpoint, and a parameter pertaining to an image capturing device used in capturing an image at the second viewpoint.

3. The measurement device according to claim 2, wherein
the parameter includes at least a parameter configured by a spatial position and an orientation of the image capturing device,
the spatial position of the image capturing device is specified by a first sensor acquiring an absolute spatial position, and
the orientation of the image capturing device is specified by a second sensor acquiring spatial orientation information.

4. The measurement device according to claim 1, wherein
the second calculator is configured to
extract a feature point from the reference image,
extract a corresponding feature point corresponding to the feature point from each of the asynchronous images, and
calculate the spatial position of the object on the basis of the feature point, the corresponding feature point, and the differences in the image capture time.

5. The measurement device according to claim 4, wherein
the parameter includes at least a parameter configured by a spatial position and an orientation of the image capturing device,
the spatial position of the image capturing device is specified by a first sensor acquiring an absolute spatial position, and
the orientation of the image capturing device is specified by a second sensor acquiring spatial orientation information.

6. The measurement device according to claim 1, wherein
a plurality of viewpoints exists in addition to the first viewpoint, and
the measurement device further comprises a selection unit configured to select, as the second viewpoint, a viewpoint from among the viewpoints excluding the first viewpoint, the selected viewpoint satisfying at least any of a condition that an estimation error of a spatial position is smaller than at the other viewpoints, a condition that there is a smaller difference in the image capture time between the reference image and an image captured at the viewpoint than between the reference image and an image captured at the other viewpoints, and a condition that image quality is higher than at the other viewpoints.

7. A measurement method comprising:
acquiring a reference image that is an image of an object captured at a first viewpoint as well as a plurality of asynchronous images of the object each captured at a second viewpoint at a time different from when the reference image is captured;
acquiring an image capture time of the reference image and an image capture time of each of the asynchronous images;
calculating a difference in the image capture times between the reference image and each of the asynchronous images; and
calculating a spatial position of the object on the basis of the reference image, the asynchronous images, and a plurality of the differences in the image capture time.

8. The method according to claim 7, wherein
the calculating a spatial position includes
using the asynchronous images and the differences in the image capture time to generate an estimated image that is estimated to be captured at the second viewpoint at the same time the reference image is captured, and
calculating the spatial position of the object by using the reference image, the estimated image, a parameter pertaining to an image capturing device used in capturing an image at the first viewpoint, and a parameter pertaining to an image capturing device used in capturing an image at the second viewpoint.

9. The method according to claim 8, wherein
the parameter includes at least a parameter configured by a spatial position and an orientation of the image capturing device,
the spatial position of the image capturing device is specified by a first sensor acquiring an absolute spatial position, and
the orientation of the image capturing device is specified by a second sensor acquiring spatial orientation information.

10. The method according to claim 7, wherein
the calculating a spatial position includes
extracting a feature point from the reference image,
extracting a corresponding feature point corresponding to the feature point from each of the asynchronous images, and
calculating the spatial position of the object on the basis of the feature point, the corresponding feature point, and the differences in the image capture time.

11. The method according to claim 10, wherein
the parameter includes at least a parameter configured by a spatial position and an orientation of the image capturing device,
the spatial position of the image capturing device is specified by a first sensor acquiring an absolute spatial position, and
the orientation of the image capturing device is specified by a second sensor acquiring spatial orientation information.

12. The method according to claim 7, wherein
a plurality of viewpoints exists in addition to the first viewpoint, and
the method further comprising selecting, as the second viewpoint, a viewpoint from among the viewpoints excluding the first viewpoint, the selected viewpoint satisfying at least any of a condition that an estimation error of a spatial position is smaller than at the other viewpoints, a condition that there is a smaller difference in the image capture time between the reference image and an image captured at the viewpoint than between the reference image and an image captured at the other viewpoints, and a condition that image quality is higher than at the other viewpoints.

13. A computer program product comprising a computer-readable medium containing a program executed by a computer, the program causing the computer to execute:
acquiring a reference image that is an image of an object captured at a first viewpoint as well as a plurality of asynchronous images of the object each captured at a second viewpoint at a time different from when the reference image is captured;
acquiring an image capture time of the reference image and an image capture time of each of the asynchronous images;
calculating a difference in the image capture times between the reference image and each of the asynchronous images; and
calculating a spatial position of the object on the basis of the reference image, the asynchronous images, and a plurality of the differences in the image capture time.

14. The product according to claim 13, wherein
the calculating a spatial position includes
using the asynchronous images and the differences in the image capture time to generate an estimated image that is estimated to be captured at the second viewpoint at the same time the reference image is captured, and
calculating the spatial position of the object by using the reference image, the estimated image, a parameter pertaining to an image capturing device used in capturing an image at the first viewpoint, and a parameter pertaining to an image capturing device used in capturing an image at the second viewpoint.

15. The product according to claim 14, wherein
the parameter includes at least a parameter configured by a spatial position and an orientation of the image capturing device,
the spatial position of the image capturing device is specified by a first sensor acquiring an absolute spatial position, and
the orientation of the image capturing device is specified by a second sensor acquiring spatial orientation information.

16. The product according to claim 13, wherein
the calculating a spatial position includes
extracting a feature point from the reference image,
extracting a corresponding feature point corresponding to the feature point from each of the asynchronous images, and
calculating the spatial position of the object on the basis of the feature point, the corresponding feature point, and the differences in the image capture time.

17. The product according to claim 16, wherein
the parameter includes at least a parameter configured by a spatial position and an orientation of the image capturing device,
the spatial position of the image capturing device is specified by a first sensor acquiring an absolute spatial position, and
the orientation of the image capturing device is specified by a second sensor acquiring spatial orientation information.

18. The product according to claim 13, wherein
a plurality of viewpoints exists in addition to the first viewpoint, and
the program further causes the computer to execute selecting, as the second viewpoint, a viewpoint from among the viewpoints excluding the first viewpoint, the selected viewpoint satisfying at least any of a condition that an estimation error of a spatial position is smaller than at the other viewpoints, a condition that there is a smaller difference in the image capture time between the reference image and an image captured at the viewpoint than between the reference image and an image captured at the other viewpoints, and a condition that image quality is higher than at the other viewpoints.
